(19) United States
(12) Patent Application Publication
(10) Pub. No.: US 2012/0000326 A1
(43) Pub. Date: Jan. 5, 2012

(54) PARALLEL ACTION PLIERS

(75) Inventor: Timothy W. Sheriff, Duluth, MN (US)

(73) Assignee: SWANSTROM TOOLS USA, Superior, WI (US)

(21) Appl. No.: 13/163,058

(22) Filed: Jun. 17, 2011

Related U.S. Application Data
(60) Provisional application No. 61/359,895, filed on Jun. 30, 2010.

(51) Int. Cl. B25B 7/12; B23P 15/00

(52) U.S. Cl. 81/354; 76/119

(57) ABSTRACT

Provided is a hand tool with a first handle portion, a first jaw portion connected to the first handle portion at a first jaw pivot located near a distal end of the first handle portion, a second handle portion connected to the first handle portion at a handle pivot, the handle pivot being located proximal of the first jaw pivot, a second jaw portion connected to the second handle portion at a second jaw pivot located near a distal end of the second handle portion, the handle pivot being located proximal of the second jaw pivot, and a first slider that is substantially elongate, has a length and a longitudinal axis along the length, the first slider extending between the first and second jaw portions and being slidably connected to the first jaw portion.

### PRIORITY

This application claims the benefit of U.S. Provisional Application No. 61/359,895, filed Jun. 30, 2010, entitled “Parallel Action Pliers,” the entirety of which is incorporated herein.

### BACKGROUND

Various types of handled tools incorporate a parallel jaw action. For example, some snap ring pliers designs having parallel jaw action have been proposed. One tool is described in U.S. Pat. No. 3,662,449 to Hashimoto as a pliers for contracting or expanding snap rings, the pliers including pivotally connected handles spring biased apart and being coupled to movable jaws by pivotable cam plates. Among other things, the jaws are guided to move linearly toward and away from each other by parallel slide members. Another example is described in U.S. Pat. No. 3,990,137 to Kulba et al. as a parallel action pliers for the manipulation of snap rings and the like. Among other things, the jaws of the pliers carry a pair of parallel pins adapted to engage the snap ring, and the parallel relationship continues as the pins are moved away from or toward one another by actuation of the plier handles.

### SUMMARY

Some aspects relate to a hand tool extending from a proximal end to a distal end. The hand tool includes a first handle portion having a proximal end and a distal end; a first jaw portion connected to the first handle portion at a first jaw pivot located near the distal end of the first handle portion; a second handle portion connected to the first handle portion at a handle pivot, the handle pivot being located proximal of the first jaw pivot; a second jaw portion connected to the second handle portion at a second jaw pivot located near the distal end of the second handle portion, the handle pivot being located proximal of the second jaw pivot; and a first slider that is substantially elongate, and has a length and a longitudinal axis along the length. The first slider extends between the first and second jaw portions and is slidably connected to the first jaw portion. Upon actuating the first and second handle portions, the first jaw portion moves along the longitudinal axis toward the second jaw portion such that the first and second jaw portions move parallel to one another in a plane of motion.

In some embodiments, the first slider is slidably connected to the first jaw portion at a location distal the first and second jaw pivots. The slider is optionally fixed relative to the first jaw portion and slidably connected to the second jaw portion. The first jaw portion optionally has a proximal end that forms an insert tab and the first handle portion has a distal end that forms a fork, the insert tab being received in the fork and pivotably secured therein. If desired, the first jaw portion defines a first face that is substantially planar and the second jaw portion defines a second face that is substantially planar, the first and second faces being oriented toward one another in an opposing fashion, and further wherein the slider extends substantially perpendicularly through the first and second faces. In some embodiments, the first jaw portion moves toward the second jaw portion when the first handle portion is moved toward the second handle portion. In other embodiments, the first jaw portion moves away from the second jaw portion when the first handle portion is moved toward the second handle portion.

In some embodiments, the first jaw portion includes a first fixture having at least one receptacle and a forming pin received in the receptacle, the forming pin extending from the receptacle in a direction substantially perpendicular to the plane of motion of the first and second jaw portions. If desired, the first fixture is substantially block-shaped and the receptacle is substantially cylindrical. The slider optionally extends through the first and second jaw portions. In some embodiments, the hand tool includes a second slider extending between the first and second jaw portions, the first and second sliders being oriented substantially parallel to one another.

In some embodiments, the first and second jaw portions have a configuration selected from flat nose, chain nose, bent chain nose, long nose, needle nose, round nose, curved nose, and curved snipe nose configurations. In some embodiments, the first and second jaw portions combine to define a forming die having a forming cavity for receiving a workpiece. The forming cavity is substantially arcuate. The first and second jaw portions each have a length and, if desired, the forming cavity extends substantially longitudinally along the lengths of the first and second jaw portions. In other embodiments, the first and second jaw portions each have a length and the forming cavity extends substantially perpendicularly across the lengths of the first and second jaw portions.

Other aspects relate to a hand tool extending from a proximal end to a distal end. The hand tool consists essentially of a first handle portion having a proximal end and a distal end; a first jaw portion connected to the first handle portion at a first jaw pivot located near the distal end of the first handle portion; a second handle portion connected to the first handle portion at a handle pivot, the handle pivot being located proximal of the first jaw pivot; a second jaw portion connected to the second handle portion at a second jaw pivot located near the distal end of the second handle portion, the handle pivot being located proximal of the second jaw pivot; a first slider that is substantially elongate, has a length and a longitudinal axis along the length, the first slider extending between the first and second jaw portions and being slidably connected to the first jaw portion such that upon actuating the first and second handle portions the first jaw portion moves along the longitudinal axis toward the second jaw portion such that the first and second jaw portions move parallel to one another in a plane of motion; and a biasing means for biasing the first and second handle portions relative to one another.

Still other aspects relate to a method of forming a hand tool exhibiting a parallel, open-close jaw action. The method includes providing a first handle portion and a first jaw portion; securing the first handle portion to the first jaw portion at a first jaw pivot; providing a second handle portion and a second jaw portion; securing the second handle portion to the second jaw portion at a second jaw pivot; securing the first handle portion to the second handle portion at a handle pivot, the handle pivot being located proximal the first and second jaw pivots; and connecting a first slider that is substantially elongate to the first jaw portion at a location distal the first and second jaw pivots such that the first jaw portion is slidable along a longitudinal axis of the first slider; and connecting the slider to the second jaw portion such that upon actuating the handles the first and second jaw portions move linearly toward one another.

In some embodiments, the method further includes forming at least one hole in the first jaw portion and inserting a wire forming mandrel in the at least one hole. The method optionally includes forming a plurality of holes in the first jaw portion each adapted to receive a wire forming mandrel and inserting wire forming mandrels in at least two of the holes. In some embodiments, the method includes forming a first die feature in the first jaw portion and a second die feature in the second jaw portion, the first and second die features being substantially complementary in shape.

This summary is not meant to be limiting in nature. While multiple embodiments are disclosed herein, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a parallel action pliers in an open state, according to some embodiments.

FIG. 2 is another perspective view of the parallel action pliers of FIG. 1 in an open state.

FIG. 3 is a perspective view of another parallel action pliers in a closed state, according to some embodiments.

FIG. 4 is another perspective view of the parallel action pliers of FIG. 3 in an open state, according to some embodiments.

FIG. 5 is a front view of a jaw portion design of a parallel action pliers, according to some embodiments.

FIG. 6 is a front view of another jaw portion design of a parallel action pliers, according to some embodiments.

FIG. 7 is a plan view of another parallel action pliers in an open state, according to some embodiments.

FIG. 8 is a perspective view of the parallel action pliers of FIG. 7.

FIG. 9 is a top view of another parallel action pliers in a closed state, according to some embodiments.

FIG. 10 is a top view of still another parallel action pliers in a closed state, according to some embodiments.

Various embodiments have been shown by way of example in the drawings and are described in detail below. As stated above, the intention, however, is not to limit the invention by providing such examples.

### DETAILED DESCRIPTION

In general terms, some embodiments address a hand tool including a slider that is substantially elongate, has a length and a longitudinal axis along the length, and extends between first and second jaw portions of the hand tool. The slider connects the first and second jaw portions in such a manner that the first and second jaw portions move along a substantially straight line of action. In some embodiments, the substantially straight line of action is along the longitudinal axis of the slider. Other embodiments address methods of making a hand tool described herein. Various additional or alternate features are described in the following detailed description with reference to the accompanying figures.

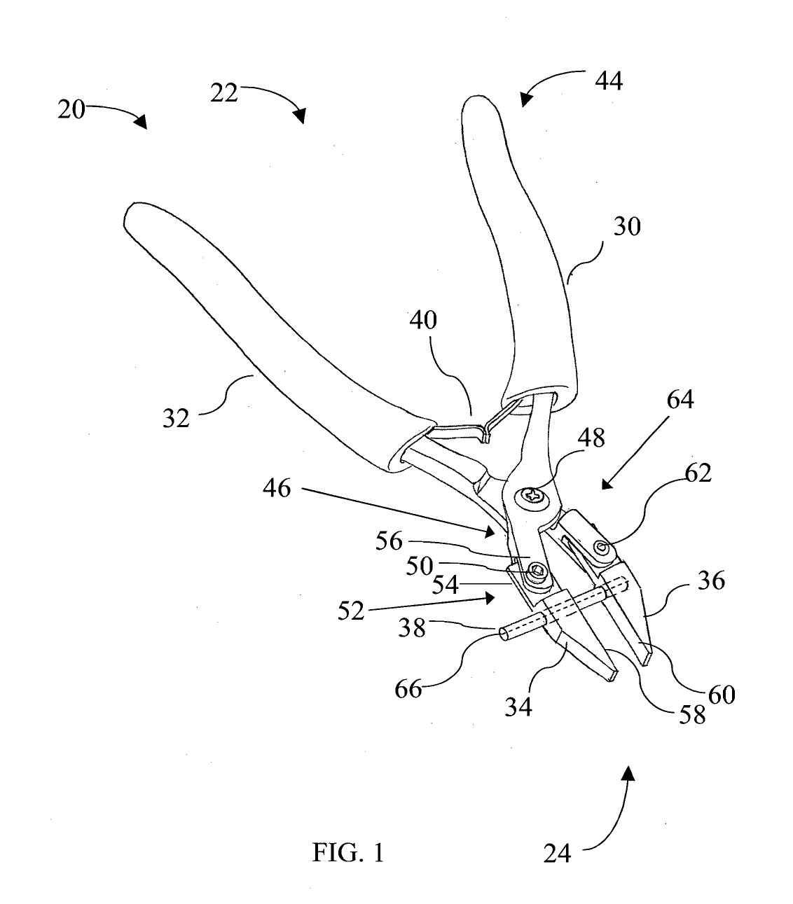

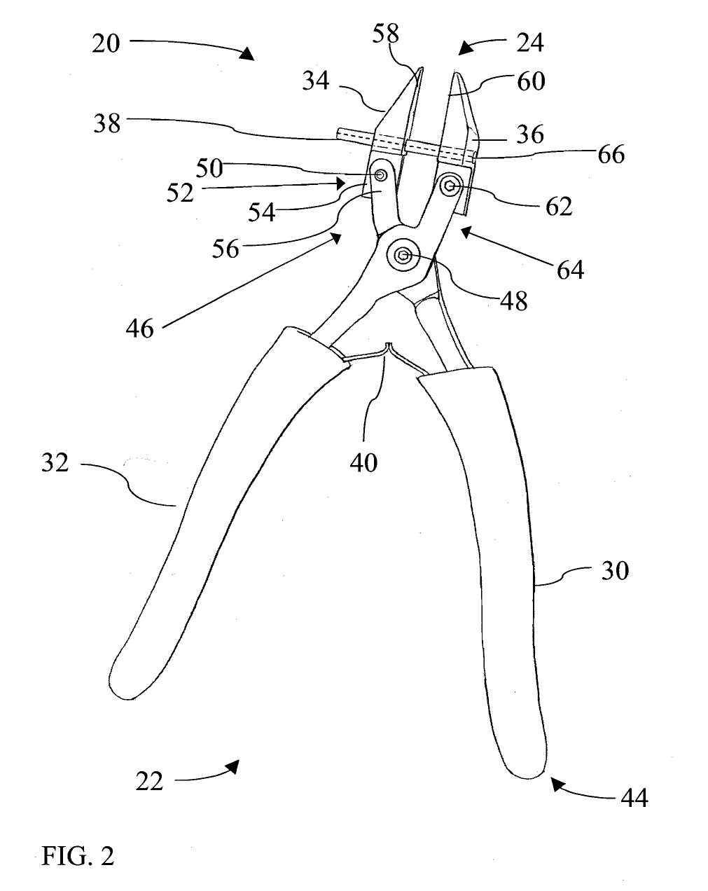

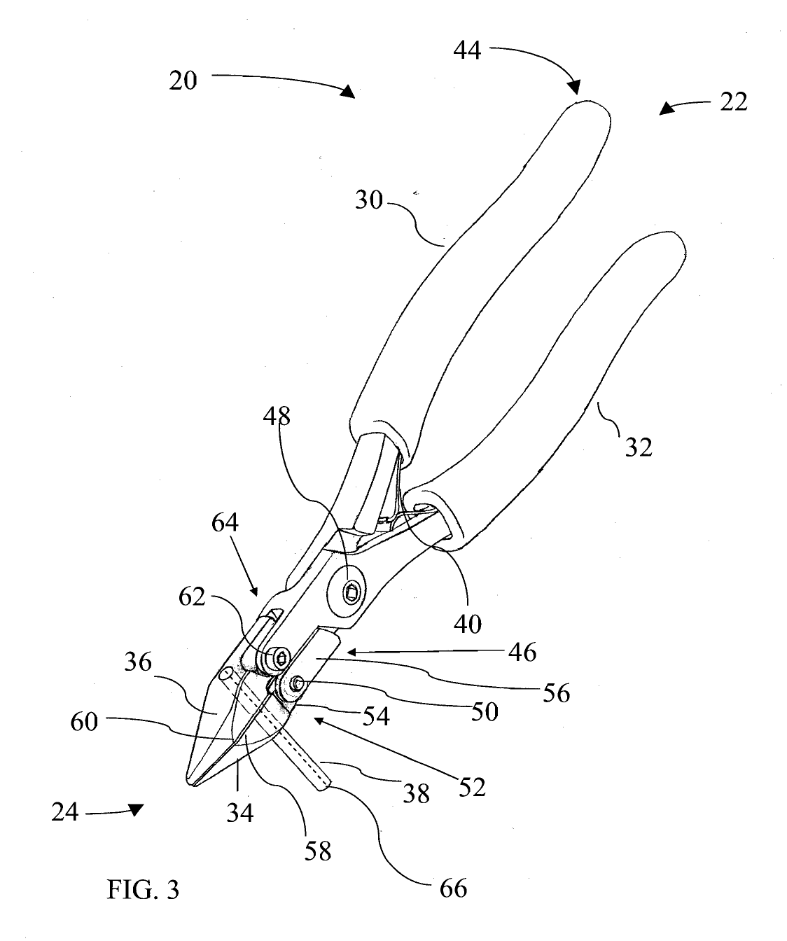

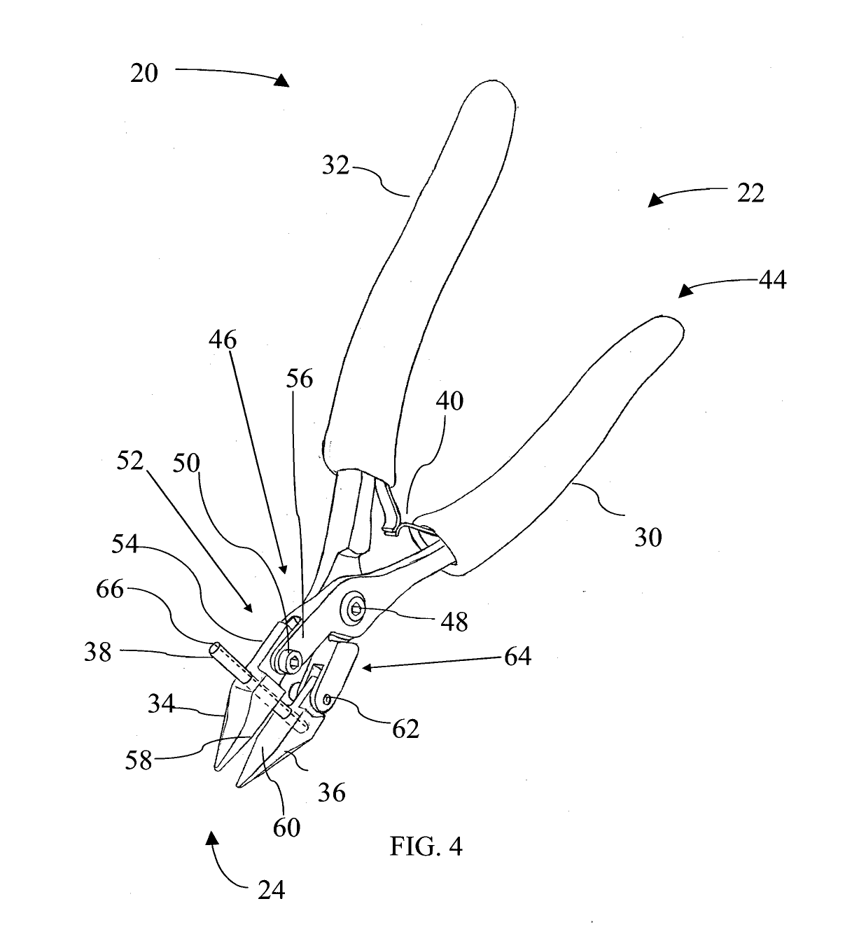

FIG. 1, FIG. 2, and FIG. 4 are perspective views of parallel action pliers 20 in an open state, according to some embodiments. FIG. 3 is a perspective view of a parallel action pliers 20 in a closed state, according to some embodiments. The pliers are in a closed state if the first and second jaw portions are positioned proximal to one another.

As shown, the parallel action pliers 20 extends from a proximal end 22 to a distal end 24 and includes a first handle portion 30, a second handle portion 32, a first jaw portion 34, a second jaw portion 36, a first slider 38, and biasing means 40. In some embodiments, the parallel action pliers 20, also described as a hand tool, is a four bar linkage (where the first slider 38 is considered a part of the first jaw portion 34) and in terms of primary functional features consists essentially of the first and second handle portions 30, 32; the first and second jaw portions 34, 36; the first slider 38; and the biasing means 40.

The first handle portion 30 has a proximal end 44 and a distal end 46. In some embodiments, the second handle portion 32 is connected to the first handle portion 30 at a handle pivot 48, the handle pivot 48 being located proximal of the first jaw pivot 50.

The first jaw portion 34 is connected to the first handle portion 30 at a first jaw pivot 50 located near the distal end 46 of the first handle portion 30. The first jaw portion 34 has a proximal end 52 that forms an insert tab 54 and the first handle portion 30 has a distal end 46 that forms a fork 56, the insert tab 52 being received in the fork 56 and pivotably secured therein. The first jaw portion 34 defines a first face 58 that is substantially planar and the second jaw portion 36 defines a second face 60 that is substantially planar, the first and second faces 34, 36 being oriented toward one another in an opposing fashion, and further wherein the slider 38 extends substantially perpendicularly through the first and second faces 58, 60.

The second jaw portion 36 is connected to the second handle portion 32 at a second jaw pivot 62 located near the distal end 64 of the second handle portion 32, the handle pivot 48 being located proximal of the second jaw pivot 62.

The first and second jaw portions 34, 36 have a configuration selected from the group consisting of a flat nose, a chain nose, a bent chain nose, a long nose, a needle nose, a round nose, a curved nose, and a curved snipe nose.

The first slider 38 is substantially elongate, having a length and a longitudinal axis 66 along the length. The first slider 38 extends between the first and second jaw portions 34, 36 and is slidably connected to the first jaw portion 34 such that upon actuating the first and second handle portions 30, 32 the first jaw portion 34 moves along the longitudinal axis 66 toward the second jaw portion 36 such that the first and second jaw portions 34, 36 move parallel to one another in a plane of motion. The first slider 38 is slidably connected to the first jaw portion 34 at a location distal the first and second jaw pivots. The first slider 38 is optionally affixed to the second jaw portion 36.

The first slider 38 is slidably connected to the second jaw portion 36, according to some embodiments. The first jaw portion 34 moves toward the second jaw portion 36 when the first handle portion 30 is moved toward the second handle portion 32. The slider 38 is fixed relative to the first jaw portion 34 and is slidably connected to the second jaw portion 36.

According to some embodiments, the slider 38 extends through the first and second jaw portions 34, 36.

The first jaw portion 34 moves away from the second jaw portion 36 when the first handle portion 30 is moved toward the second handle portion 32, according to some embodiments.

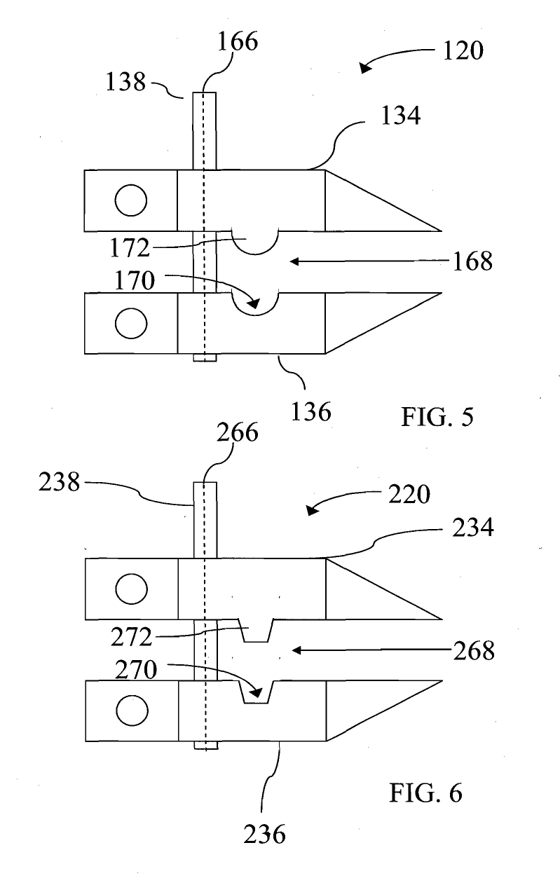

FIG. 5 is a front view of a jaw portion design of a parallel action pliers 120, according to some embodiments. The first and second jaw portions 134, 136 combine to define a forming die 168 having a forming cavity 170 for receiving a workpiece 172. The forming cavity 170 is substantially arcuate. The first and second jaw portions 134, 136 each have a length and the forming die 168 extends substantially longitudinally along the lengths of the first and second jaw portions 134, 136. The first and second jaw portions 134, 136 each have a length and the forming die 168 extends substantially perpendicularly across the lengths of the first and second jaw portions 134, 136. The first slider 138 is substantially elongate, having a length and a longitudinal axis 166 along the length. The first slider 138 extends between the first and second jaw portions 134, 136 and is slidably connected to the first jaw portion 134.

FIG. 6 is a front view of a jaw portion design of a parallel action pliers 220, according to some embodiments. The first and second jaw portions 234, 236 combine to define a forming die 268 having a forming cavity 270 for receiving a workpiece 272. The forming cavity 272 is substantially quadrilateral.

The first and second jaw portions 234, 236 each have a length and the forming die 268 extends substantially longitudinally along the lengths of the first and second jaw portions 234, 236. The first and second jaw portions 34, 36 each have a length and the forming die 268 extends substantially perpendicularly across the lengths of the first and second jaw portions 234, 236. The first slider 238 is substantially elongate, having a length and a longitudinal axis 266 along the length. The first slider 238 extends between the first and second jaw portions 234, 236 and is slidably connected to the first jaw portion 234.

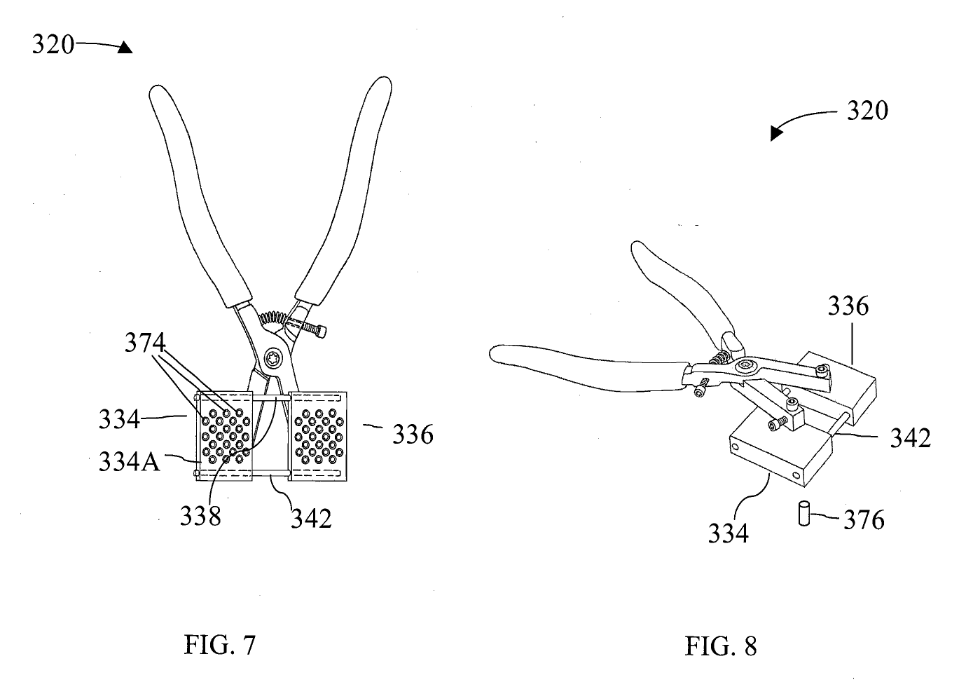

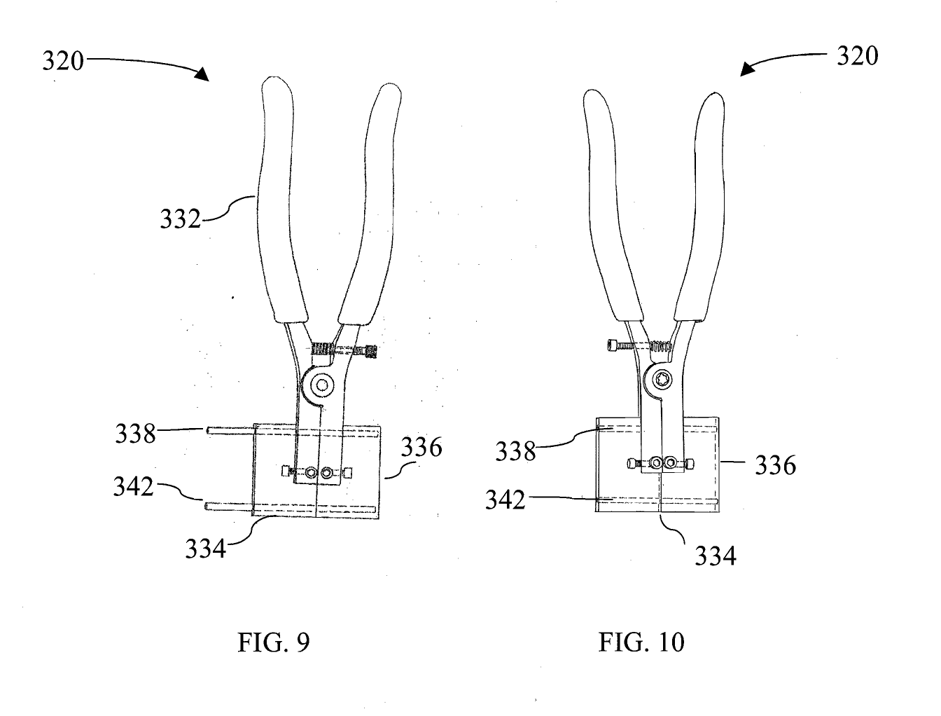

FIG. 7 is a plan view of another parallel action pliers 320 in an open state, according to some embodiments. FIG. 8 is a perspective view of the parallel action pliers 320 of FIG. 7. FIG. 9 and FIG. 10 are top views of the parallel action pliers 320 in a closed state, according to some embodiments. As shown, a second slider 342 extends between the first and second jaw portions 334, 336, the first and second sliders 338, 342 are oriented substantially parallel to one another. FIG. 9 is an embodiment in which the first and second sliders 338, 342 extend beyond the first jaw portion 334 when the parallel action pliers 320 is in a closed state. FIG. 10 is an embodiment in which the first and second sliders 338, 342 do not extend beyond the first jaw portion 334 when the parallel action pliers 320 is in a closed state.

The first and second jaw portions 334, 336 are substantially plate-shaped. The first jaw portion 334 comprises a first fixture 334A having at least one receptacle 374 and a forming pin 376 received in the receptacle 374, the forming pin 376 extending from the receptacle 374 in a direction substantially perpendicular to the plane of motion of the first and second jaw portions 334, 336. The first fixture 334A is substantially block-shaped and the at least one receptacle 374 is substantially cylindrical.

A method of forming a hand tool 20 exhibiting a parallel, open-close jaw action generally comprises securing the first handle portion 30 to the first jaw portion 34 at the first jaw pivot 50; securing the second handle portion 32 to the second jaw portion 36 at the second jaw pivot 62; and securing the first handle portion 30 to the second handle portion 32 at the handle pivot 48, the handle pivot 48 being located proximal the first and second jaw pivots 50, 62.

In some embodiments, the method includes connecting the first slider 38 to the first jaw portion 34 at a location distal the first and second jaw pivots 50, 62 such that the first jaw portion 34 is slidable along the longitudinal axis 66 of the first slider 38. In some embodiments, the method additionally includes connecting the slider 38 to the second jaw portion 36 such that upon actuating the handles 30, 32 the first and second jaw portions 34, 36 move linearly toward one another.

The method optionally includes connecting a first slider 38 to the second jaw portion 36 such that the second jaw portion 36 is slidable along the longitudinal axis 66 of the first slider 38. The method optionally includes connecting the slider 38 to the first jaw portion 34 such that upon actuating the handles 30, 32 the first and second jaw portions 34, 36 move linearly toward one another.

In some embodiments, the method includes forming at least one hole 374, also described herein as a receptacle, in the first jaw portion 334 and inserting a wire forming mandrel 376, also described herein as a forming pin, in the at least one hole 374. In some embodiments, the method includes forming a plurality of holes 374 in the first jaw portion 334 each adapted to receive a wire forming mandrel 376 and inserting wire forming mandrels 376 in at least two of the holes 374. The method also optionally includes forming at least one hole 374 in the second jaw portion 336 and inserting a wire forming mandrel 376 in the at least one hole 374.

In some embodiments, the method includes forming a first die feature 172 in the first jaw portion 134 and a second die feature 170 in the second jaw portion 136, the first and second die features 172, 174 being substantially complementary in shape.

The method optionally includes attaching a biasing means 40 to the first handle portion 30 and/or the second handle portion 32 to bias the handles away from or toward one another. In some embodiments, the method includes attaching a biasing means 40 to both the first and second handle portions 30, 32.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

I claim:

1. A hand tool extending from a proximal end to a distal end, the hand tool comprising:
a first handle portion having a proximal end and a distal end;
a first jaw portion connected to the first handle portion at a first jaw pivot located near the distal end of the first handle portion;
a second handle portion connected to the first handle portion at a handle pivot, the handle pivot being located proximal of the first jaw pivot;
a second jaw portion connected to the second handle portion at a second jaw pivot located near the distal end of the second handle portion, the handle pivot being located proximal of the second jaw pivot; and
a first slider that is substantially elongate, has a length and a longitudinal axis along the length, the first slider extending between the first and second jaw portions and being slidably connected to the first jaw portion such that upon actuating the first and second handle portions the first jaw portion moves along the longitudinal axis toward the second jaw portion such that the first and second jaw portions move parallel to one another in a plane of motion.

2. The hand tool of claim 1, wherein the first slider is slidably connected to the first jaw portion at a location distal the first and second jaw pivots.

3. The hand tool of claim 1, wherein the first jaw portion has a proximal end that forms an insert tab and the first handle portion has a distal end that forms a fork, the insert tab being received in the fork and pivotably secured therein.

4. The hand tool of claim 1, wherein the first slider is affixed to the second jaw portion.

5. The hand tool of claim 1, wherein the first slider is slidably connected to the second jaw portion.

6. The hand tool of claim 1, wherein the first jaw portion moves toward the second jaw portion when the first handle portion is moved toward the second handle portion.

7. The hand tool of claim 1, wherein the first jaw portion moves away from the second jaw portion when the first handle portion is moved toward the second handle portion.

8. The hand tool of claim 1, wherein the first jaw portion comprises a first fixture having at least one receptacle and a forming pin received in the receptacle, the forming pin extending from the receptacle in a direction substantially perpendicular to the plane of motion of the first and second jaw portions.

9. The hand tool of claim 8, wherein the first fixture is substantially block-shaped and the at least one receptacle is substantially cylindrical.

10. The hand tool of claim 1, wherein the first jaw portion defines a first face that is substantially planar and the second jaw portion defines a second face that is substantially planar, the first and second faces being oriented toward one another in an opposing fashion, and further wherein the slider extends substantially perpendicularly through the first and second faces.

11. The hand tool of claim 1, wherein the slider extends through the first and second jaw portions.

12. The hand tool of claim 1, wherein the first and second jaw portions combine to define a forming die having a forming cavity for receiving a workpiece.

13. The hand tool of claim 12, wherein the forming cavity is substantially arcuate.

14. The hand tool of claim 12, wherein the first and second jaw portions each have a length and the forming cavity extends substantially longitudinally along the lengths of the first and second jaw portions.

15. The hand tool of claim 12, wherein the first and second jaw portions each have a length and the forming cavity extends substantially perpendicularly across the lengths of the first and second jaw portions.

16. The hand tool of claim 1, further comprising a second slider extending between the first and second jaw portions, the first and second sliders being oriented substantially parallel to one another.

17. The hand tool of claim 1, wherein the first and second jaw portions are substantially plate-shaped.

18. The hand tool of claim 1, wherein the first and second jaw portions have a configuration selected from the group consisting of a flat nose, a chain nose, a bent chain nose, a long nose, a needle nose, a round nose, a curved nose, and a curved snipe nose.

19. The hand tool of claim 1, further comprising a biasing means for biasing the first and second handle portions relative to one another.

20. A hand tool extending from a proximal end to a distal end, the hand tool consisting essentially of:
a first handle portion having a proximal end and a distal end:
a first jaw portion connected to the first handle portion at a first jaw pivot located near the distal end of the first handle portion;
a second handle portion connected to the first handle portion at a handle pivot, the handle pivot being located proximal of the first jaw pivot;
a second jaw portion connected to the second handle portion at a second jaw pivot located near the distal end of the second handle portion, the handle pivot being located proximal of the second jaw pivot; and
a first slider that is substantially elongate, has a length and a longitudinal axis along the length, the first slider extending between the first and second jaw portions and being slidably connected to the second jaw portion such that upon actuating the first and second handle portions the first jaw portion moves along the longitudinal axis toward the second jaw portion such that the first and second jaw portions move parallel to one another in a plane of motion.

21. The hand tool of claim 20, wherein the slider is fixed relative to the first jaw portion.

22. A method of forming a hand tool exhibiting a parallel, open-close jaw action, the method comprising:
securing a first handle portion to a first jaw portion at a first jaw pivot;
securing a second handle portion to a second jaw portion at a second jaw pivot;
securing the first handle portion to the second handle portion at a handle pivot, the handle pivot being located proximal the first and second jaw pivots;
connecting a first slider that is substantially elongate to the first jaw portion at a location distal the first and second jaw pivots such that the first jaw portion is slidable along a longitudinal axis of the first slider; and
connecting the slider to the second jaw portion such that upon actuating the handles the first and second jaw portions move linearly toward one another.

23. The method of claim 22, further comprising forming at least one hole in the first jaw portion and inserting a wire forming mandrel in the at least one hole.

24. The method of claim 22, further comprising forming a plurality of holes in the first jaw portion each adapted to receive a wire forming mandrel and inserting wire forming mandrels in at least two of the holes.

25. The method of claim 22, further comprising forming a first die feature in the first jaw portion and a second die feature in the second jaw portion, the first and second die features being substantially complementary in shape.
